(19) United States
(12) Patent Application Publication
(10) Pub. No.: US 2010/0267383 A1
(43) Pub. Date: Oct. 21, 2010

(54) DETERMINING AND SELECTING THE MOST PREFERRED AVAILABLE NETWORK FOR DEVICES CAPABLE OF MULTIPLE RADIO ACCESS TECHNOLOGIES

(76) Inventors: Kyriaki Konstantinou, New York, NY (US); Iftekhar Rahman, Billerica, MA (US); Zheng Zhao, Plainsboro, NJ (US); Carl R. Anderson, Holmdel, NJ (US); Gerry Libunao, Manalapan, NJ (US)

Correspondence Address: MCDERMOTT WILL & EMERY LLP, 600 13TH STREET, N.W., WASHINGTON, DC, 20005-3096, US

(21) Appl. No.: 12/424,339

(22) Filed: Apr. 15, 2009

(51) Int. Cl. H04W 60/00

(52) U.S. Cl. 455/435.2

(57) ABSTRACT

The algorithm disclosed here is a method for a mobile station device to select a network for wireless communications in a way that takes advantage of the most favorable roaming agreements between operators. The exemplary algorithm provides the flexibility to select between 3GPP2 (1×RTT and EVDO) technologies and 3GPP (LTE/GSM/UMTS) technologies as well as specific operators' networks for domestic and international roaming. The proposed algorithm allows the operator to optimize roaming agreements in different markets and maximize revenue from roaming.

### TECHNICAL FIELD

The present subject matter relates to techniques and equipment to select a network for wireless communications in a way that takes advantage of the most favorable roaming agreements between operators, for example, with sufficient flexibility to select between 3GPP2 (1×RTT and EVDO) technologies and 3GPP (LTE/GSM/UMTS) technologies as well as specific operators' networks for domestic and international roaming so as to allow the operator to optimize roaming agreements in different markets and maximize revenue from roaming.

### BACKGROUND

In recent years, use of mobile communications devices for voice telephone services, email or text messaging services and even multi-media services has become commonplace, among mobile professionals and throughout the more general consumer population. Mobile service provided through public cellular or PCS (personal communication service) type networks, particularly for voice telephone service, has become virtually ubiquitous across much of the world. The rapid expansion of such mobile communication services has resulted in deployment of a variety of different and often incompatible wireless network technologies, in different jurisdictions or regions and in some cases as competing services within the same area. A large carrier may operate its network over a wide geographic area and have roaming agreements with operators of other compatible technology networks in other areas. However, occasions still arise in which a service technology of a home network service provider may not be available in a visited area or region into which a customer roams and intends to use her mobile station. To allow continued operation in regions where the local provider offers service via a different technology, station manufactures have developed dual or multi mode mobile stations, which have the capability of communicating via two or more wireless mobile technologies.

Hence, global devices that use 3GPP2 type CDMA technologies (1×RTT and EVDO) are also required to operate in networks that support 3GPP technologies (GSM/UMTS/LTE). This is necessary because in many countries around the world CDMA is not deployed. One example would be European countries where a CDMA device would have no coverage at all. In addition, there are many countries, e.g., China and India, where both 3GPP2 and 3GPP based networks exist with extensive coverage.

To facilitate customer roaming where a particular operator may not have network coverage, the service provider or operator of one network will have agreements with other operators/service providers. Under such agreements, customers of the other operators may roam-in and use the one provider's network, whereas customers of the one provider may roam-out and use the networks of the other operators/service providers. As a result of the differences in network technologies and the availability of multimode mobile stations, there may be roaming agreements with operators providing the two different technologies.

However, different agreements among the parties may have different terms. As a result, some agreements may be more favorable, and a particular operator or service provider may ‘prefer’ for its customers to utilize the network of a particular other provider in certain areas.

Technology preferences may vary from country to country and may be subject to frequent changes over time. In different countries, for example, any given multi-mode mobile station device may be required to operate on the currently most preferred networks of various compatible technologies. Devices with the capability to support both 3GPP2 and 3GPP technologies also need a means of selecting a specific system (network) with which to establish wireless communication. The aim of such a system selection mechanism is to enable the device to select the network of a roaming partner when not operating in the home network. Both standards bodies, 3GPP and 3GPP2, have developed procedures for doing so. However, since the 3GPP2 and 3GPP standards bodies are working independently, the system selection procedures that they have established are different and use databases that are structured differently. 3GGP2 uses a Preferred Roaming List (PRL) that contains a table which identifies all of the operators that are roaming partners and which lists those partner operators in priority order. Priority depends on the roaming agreements between operators. 3GPP uses Public Land Mobile Network (PLMN) lists to do the same.

One solution for a device supporting both 3GPP and 3GPP2 technologies would be to incorporate information and procedures from 3GPP to 3GPP2 technologies or vice versa. This requires a lot of effort and the need to manage in the future translation of information from PRL format to PLMN list format (or vice versa).

Another approach might always assume that one technology is preferred, and search for a network supporting that technology first. Only if the preferred technology network is unavailable, would the mobile device look for the technology of the other less preferred type. This approach, however, often will result in a mobile station selecting a preferred technology network despite the fact that the operator may not offer the most favorable roaming agreement with the customer's home service provider.

Hence, there is a need for improvement in a technique to select a network for wireless communications from among various possible network technologies that may be available in different countries or regions, in a way that takes advantage of the most favorable roaming agreements between operators, e.g. for domestic and international roaming.

### SUMMARY

In a disclosed exemplary solution, a high order list is used to select a preferred technology based on region of operation, e.g. based on country. The mobile station has a system or network preference list for each of the technologies that it may use. The mobile station determines its region of operation and uses the technology preference list to select the most preferred technology for the current region of operation. Based on the technology selection, the mobile station uses one of its system preference lists to select the most preferred available network offering mobile communication service via the selected technology. If the search using the list for the selected technology is unsuccessful, the procedure may be repeated using the system or network preference list for the next most preferred technology for the particular region of operation (as indicated by the high order technology preference list).

A more specific example discussed here utilizes an algorithm that enables the device to select systems listed in either a PRL or a PLMN list depending on the operator's roaming preferences for every country. The algorithm uses higher order lists to select the access technology (3GPP or 3GPP2) and then utilizes the appropriate procedures and network preference lists for each technology. The higher order lists provide, in order of roaming preference, the desired access technology and corresponding groups of roaming partners that point directly to PRL or PLMN lists. These higher order lists are standardized data structures that can be changed and downloaded to the device whenever roaming agreements change to address business needs. The advantage of the exemplary approach is that it exploits long established procedures and lists (which are, however, incompatible) while giving the operator the flexibility to move between 3GPP2 and 3GPP technologies and maximize revenue from favorable roaming agreements.

The exemplary algorithm provides the flexibility to select between 3GPP2 (1×RTT and EVDO) technologies and 3GPP (LTE/GSM/UMTS) technologies as well as specific operators' networks for domestic and international roaming. The disclosed algorithm allows the operator to optimize roaming agreements in different markets and maximize revenue from roaming.

The system selection algorithm as outlined above may be implemented as various combinations of method technologies, mobile station hardware and associated software (program instructions and selection lists). The software may be downloaded from system hardware connected to communicate with the mobile station directly or via the network(s). System hardware may comprise special purpose hardware or one or more general purpose devices programmed to implement the software download functions. A software product includes at least one machine-readable medium and information carried by the medium. The information carried by the medium may be executable program code and data for the various lists, which enable a programmable mobile station device to implement the system selection-related functions like those discussed in more detail below.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIGS. 1 to 3 are flow charts illustrating examples of the processing that may be implemented in a mobile station, to perform network selection with multi-mode/technology capabilities.

FIG. 4 is a high level functional block diagram, useful in explaining mobile stations, network elements and other components that may be involved in mobile station communications and related system selection functions.

FIG. 5 is a high level functional block diagram of a handset type example of a mobile station, which may be configured to perform system selection in accord with the procedures of FIGS. 1-3.

FIG. 6 is a simplified functional block diagram of a computer that may be configured as a host or server.

FIG. 7 is a simplified functional block diagram of a personal computer or other work station or terminal device.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The various technologies disclosed herein relate to mobile station selection of a network for wireless communications, where the mobile station is capable of communications via a number of different technologies. Preferably, the selection technique enables the multi-mode mobile station to generally take advantage of the most favorable roaming agreements between network operators. The selection algorithm, for example, provides the flexibility to select between 3GPP2 (1×RTT and EVDO) technologies and 3GPP (LTE/GSM/UMTS) technologies as well as specific operators' networks for domestic and international roaming. The exemplary algorithm discussed below allows the operator to optimize roaming agreements in different markets and maximize revenue from the roaming of its customers.

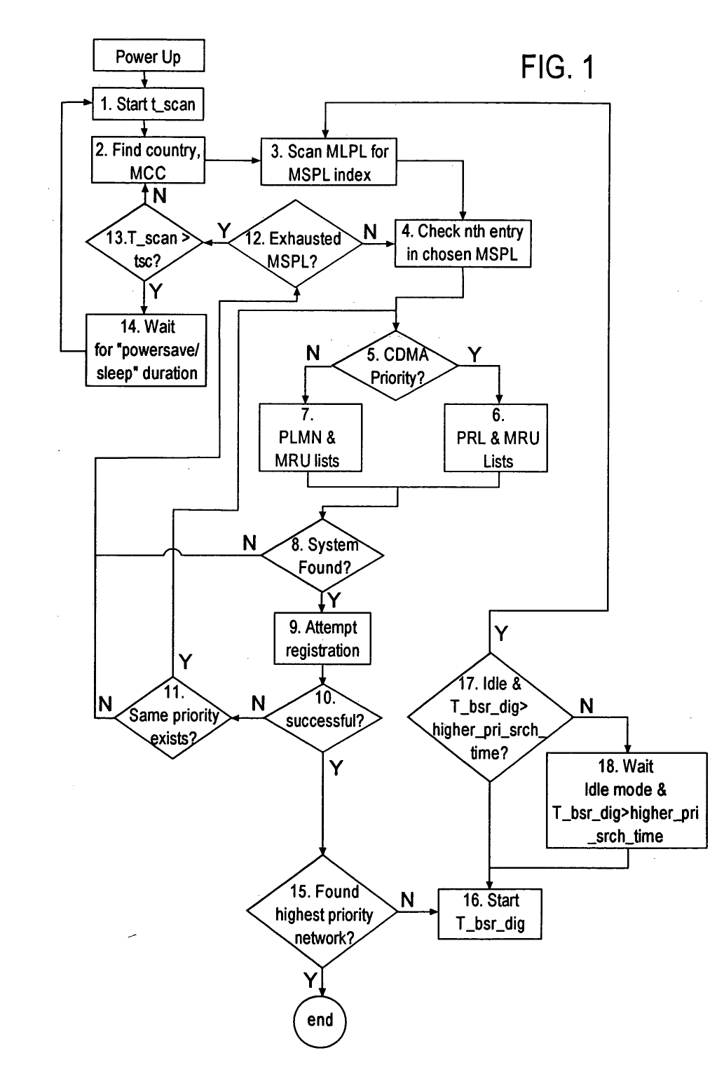

Reference now is made in detail to the examples illustrated in the accompanying drawings and discussed below. FIGS. 1 to 3 are flow charts that illustrate an example of the technique for a multi-mode/technology capable mobile station to select a network for wireless communications. At a high level, the mobile station utilizes a high order list, which identifies a preferred technology for each of the countries in which the operator's mobile stations may roam and obtain service. Hence, the mobile station identifies the country of current operation, typically from over-the-air signaling received from a base station of a network in the currently visited area. Using the high order technology preference list and the country identification, the mobile station selects the preferred technology for the region within which the mobile station is currently operating.

The mobile station also utilizes a number of network or system preference lists supported by respective standards for the various network technologies that the mobile station is capable of using. For example, if the mobile station device supports 3GPP2 technologies and 3GPP technologies, the device would have one or more PRL type lists and one or more PLMN lists. Having picked one of the technologies based on the country and the high order technology preference list, the mobile station uses the selected one of the technologies to search for the most preferred network or system of the particular technology type and applies the corresponding system or network selection list. Essentially, the mobile station scans for system identifiers using the selected technology communications and picks the network or system of that technology that has the highest priority as indicated on the list corresponding to the selected technology. Then, the mobile station will register for communication via that identified network.

However, if the mobile station can not find a network that is identified on the system or network preference list for the initially selected technology, it will select another system preference list for an alternate technology and execute a generally similar procedure (but conforming to the protocol(s) of the second technology standard) to identify and register with the most preferred network or system on the alternate list. If there are only two technologies, the mobile station simply shifts to the alternate technology and associated preference list. If there are more than two technologies and associated system preference lists, the second technology is selected based on the next highest priority in the high order list. In this later case, the process may shift to a third list and so on, if the second (and subsequent) preference list searches via the respective technologies are unsuccessful.

With that overview, we will now consider a more specific example of the selection algorithm, with reference to the flow charts of FIGS. 1 to 3. This example supports selection between 3GPP2 (1×RTT and EVDO) technologies and 3GPP (LTE/GSM/UMTS) technologies as well as specific operators' networks for domestic and international roaming. Those skilled in the art will recognize, however, that the algorithm may support other selections, e.g. between different or additional numbers of wireless communication network technologies.

In a typical commercial implementation, the multi-mode mobile station supports operation via at least one 3GPP2 technology and supports operation via at least one 3GPP technology. There are more than one 3GPP and 3GPP2 technologies. Examples of 3GPP technologies are GSM UMTS, LTE etc.; and examples of 3GPP2 technologies are 1×RTT and EVDO. For each country, the higher order technology preference list of countries specifies a preference for one or more 3GPP2 technologies and one or more 3GPP technologies. An example of the higher order preference list for a particular country could be like this: 1st priority LTE (3GPP), 2nd priority 1×RTT (3GPP2), 3rd priority UMTS etc. So the mobile would look for 3GPP (LTE) technology first. If the mobile station does not find LTE, it would then look for 3GPP2 (1×RTT), and if it did not find 1×RTT, it would look again for a 3GPP (UMTS specifically) technology.

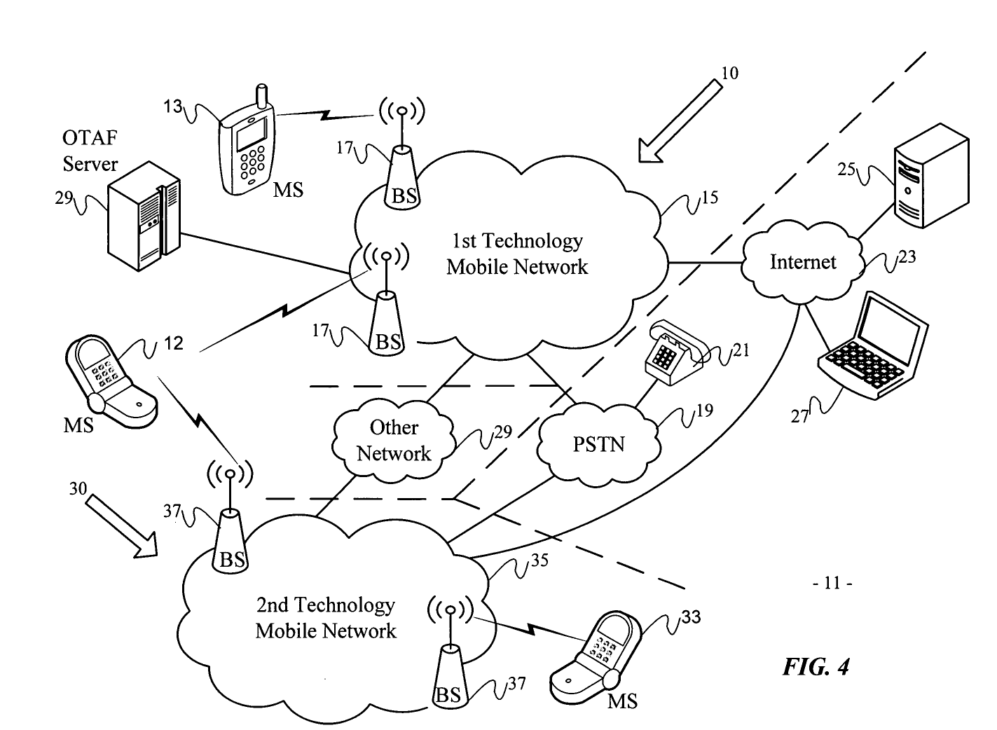

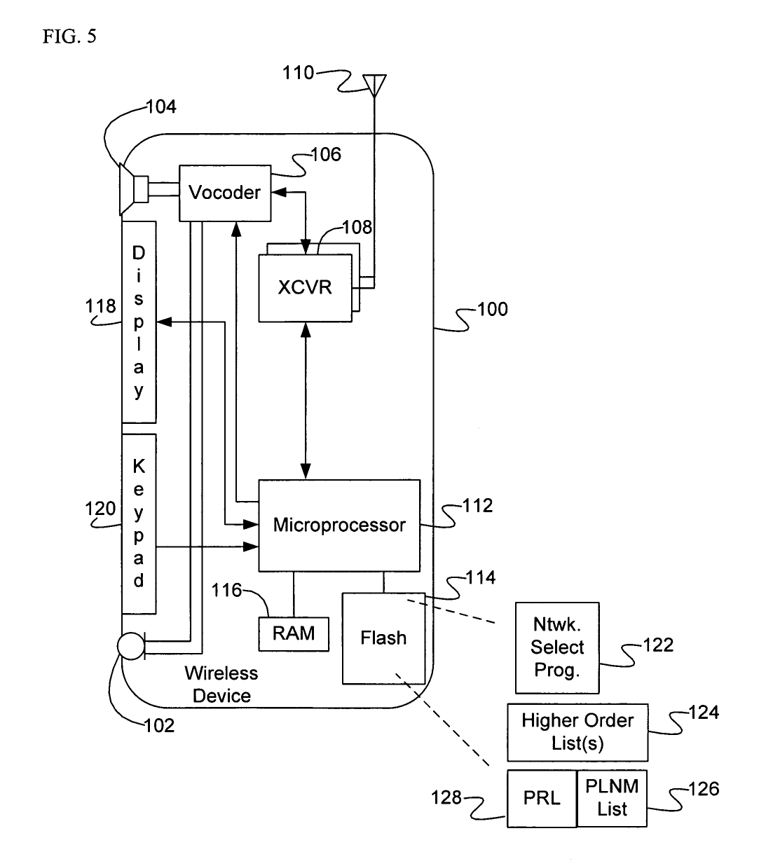

With reference to the flow charts, the following is an outline of the steps of the exemplary network selection algorithm. An exemplary network in which the mobile station may operate and search is described later, with regard to FIG. 4. The device referred to in the outline is typically a mobile station, an example of which will be described in more detail later with regard to FIG. 5.

Step 1—The device shall start a timer “t-scan”.

Step 2—The device shall determine the country (MCC) where it is operating at.

Step 3—The device shall look first in the MLPL. It shall determine the appropriate MSPL entry using MCC, MCC/MNC or MCC/tag_ID according to standard TIA/EIA/IS-683-D; Over-the-Air Service Provisioning of Mobile Stations in Spread Spectrum Systems, 2009, Telecommunications Industry Association. If the country is not included in the MLPL the device shall select the default MSPL entry.

Step 4—The device shall examine the first item in the MSPL chosen at step 3.

Step 5—If the currently examined item in the MSPL calls for a CDMA technology system, the device shall go to step 6 to find/select a CDMA system. Otherwise the device shall go to step 7 to find/ select a 3GPP system.

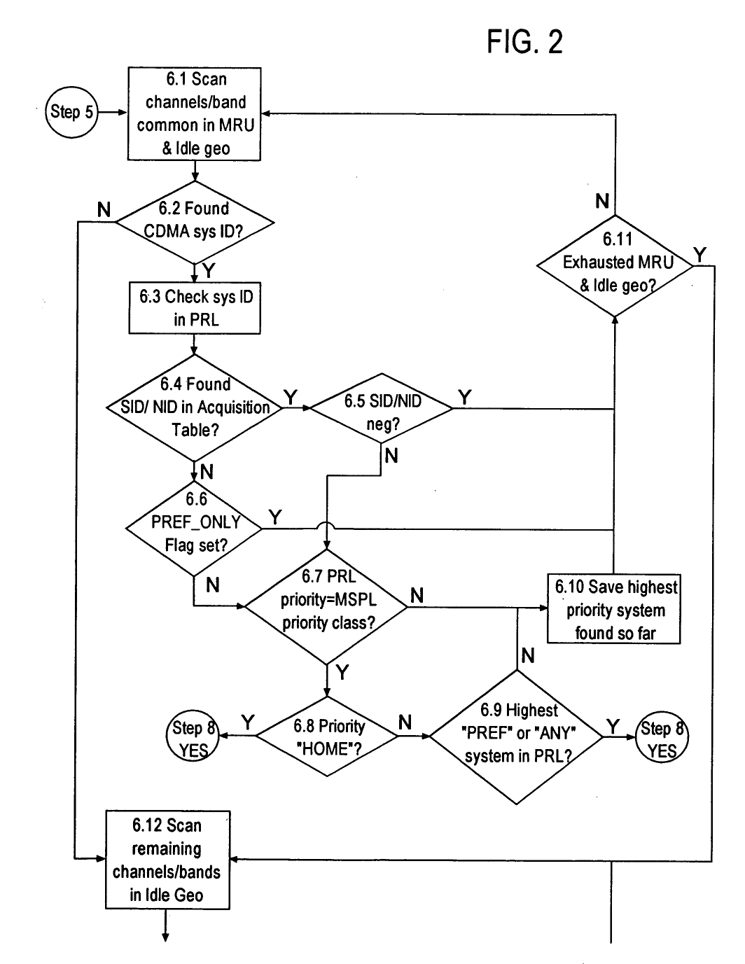

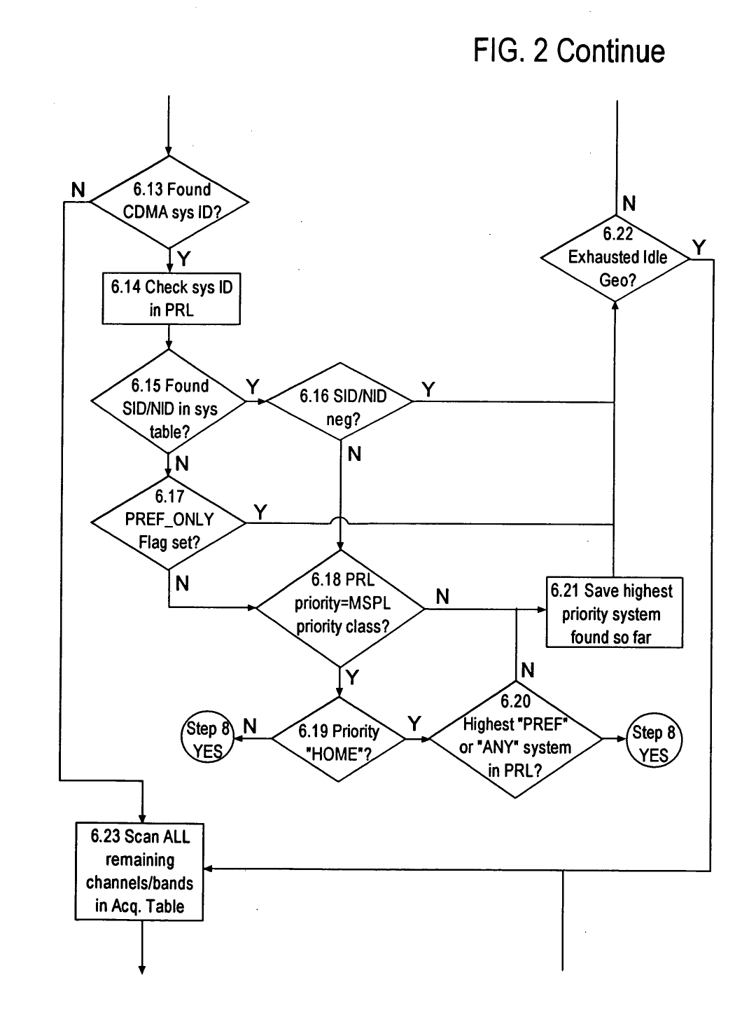

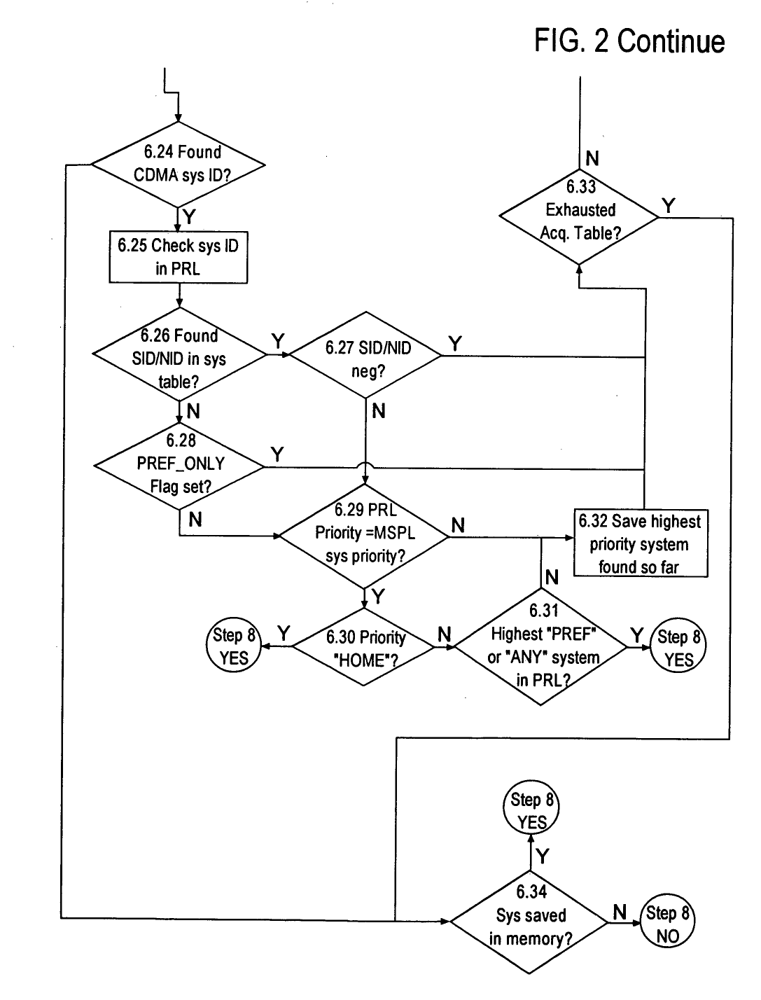

Step 6—The device shall use the CDMA radio access technology to scan the channels and bands that appear in the MRU, Idle GEO and PRL lists to find and select a CDMA system with the same priority class as the MSPL item in step 3. The mapping between MSPL priority class and PRL priority is defined in Table 1. The device shall search and select a CDMA system by going through the following steps (see FIG. 2).

TABLE 1

| MSPL | 3GPP - | |
|---|---|---|
| priority class | PLMN lists priority | CDMA - PRL priority |
| HOME | Home PLMN (HPLMN) & | Highest priority |
| | equivalent HPLMNs | network(s)(top in GEO) |
| | (eHPLMN list) | |
| PREF | Operator preferred PLMNs | 2^{nd} highest priority |
| | (OPLMN list) | network(s) |
| ANY | User preferred PLMNs | All systems except NEG |
| | (PLMN list) & any system | and, if PREF_ONLY flag |
| | except forbidden ones | set to true, systems not |
| | | included in PRL |

Step 6.1—The device shall scan the channels and bands that appear in common in both the MRU and the Idle GEO lists to detect a system identifier (SID/NID) pair.

Step 6.2—If a CDMA system identifier is not detected in step 6.1, the device shall go to step 6.12. Otherwise the device shall go to step 6.3

Step 6.3—The device shall examine the PRL for information about the detected system identifier.

Step 6.4—If the system identifier is present in the PRL, the device shall go to step 6.5 to check if this SID/NID is classified as negative. Otherwise it shall go to step 6.6 to check the PREF_ONLY flag.

Step 6.5—If the SID/NID is classified as negative, the device shall go to step 6.11 to scan the remaining channels and bands common to MRU and Idle GEO lists. Otherwise the device shall go to step 6.7

Step 6.6—If the PREF_ONLY flag is set to true, the device shall go to step 6.11 to scan the remaining channels and bands common to MRU and Idle GEO lists. Otherwise the device shall go to step 6.7

Step 6.7—If the detected system has the same priority in the PRL as the priority class of the currently examined item in MSPL (from step 3), the device shall go to step 6.8 (the priority classes for PRL and MSPL have been defined as in Table 1). If not, the device shall go to step 6.10.

Step 6.8—If the detected system is within the priority class HOME, the device shall go to step 8 to start registration procedures. Otherwise the device shall go to step 6.9.

Step 6.9—If the detected system is the most preferred one (due to its position in the PRL) within its MSPL priority class (PREF or ANY), the device shall go to step 8 to start registration procedures. Otherwise the device shall go to step 6.10.

Step 6.10—The device shall save in volatile memory the highest priority system found so far. If the system detected in step 6.2 has higher priority than the one previously saved (if any), it shall replace it. Otherwise the device shall retain the system already in memory.

Step 6.11—If all the channels and bands that appear in common in both the MRU and the Idle GEO lists have been scanned, the device shall go to step 6.12. Otherwise the device shall go back to step 6.1 to scan the next channel/band common to MRU and Idle GEO lists.

Step 6.12—The device shall scan the bands and channels in the Idle GEO list that have not been previously scanned to detect a system identifier (SID/NID) pair.

Step 6.13—If a CDMA system identifier is not detected in step 6.12, the device shall go to step 6.23. Otherwise the device shall go to step 6.14.

Step 6.14—The device shall examine the PRL for information about the detected system identifier.

Step 6.15—If the system identifier is present in the PRL, the device shall go to step 6.16 to check if this SID/NID is classified as negative. Otherwise it shall go to step 6.17 to check the PREF_ONLY flag.

Step 6.16—If the SID/NID is classified as negative the device shall go to step 6.22 to scan the remaining channels and bands in the Idle GEO list. Otherwise the device shall go to step 6.18

Step 6.17—If the PREF_ONLY flag is set to true, the device shall go to step 6.22 to scan the remaining channels and bands in the Idle GEO list. Otherwise the device shall go to step 6.18

Step 6.18—If the detected system has the same priority in the PRL as the priority class of the currently examined item in MSPL (from step 3), the device shall go to step 6.19 (the priority classes for PRL and MSPL have been defined the (Table 1). If not, the device shall go to step 6.21.

Step 6.19—If the detected system is within the priority class HOME, the device shall go to step 8 to start registration procedures. Otherwise the device shall go to step 6.20.

Step 6.20—If the detected system is the most preferred one (due to its position in the PRL) within its MSPL priority class (PREF or ANY), the device shall go to step 8 to start registration procedures. Otherwise the device shall go to step 6.21.

Step 6.21—The device shall save in volatile memory the highest priority system found so far. If the system detected in step 6.13 has higher priority than the one previously saved (if any), it shall replace it. Otherwise the device shall retain the system already in memory.

Step 6.22—If all the channels and bands that appear in Idle GEO lists have been scanned, the device shall go to step 6.23. Otherwise the device shall go back to step 6.13 to scan the next channel/band in the Idle GEO list that has not been previously scanned.

Step 6.23—The device shall scan all the channels in all the bands in the PRL Acquisition Table that have not been previously scanned to detect a system identifier (SID/NID) pair.

Step 6.24—If a CDMA system identifier is not detected in step 6.13 the device shall go to step 6.34. Otherwise the device shall go to step 6.25.

Step 6.25—The device shall examine the PRL for information about the detected system identifier.

Step 6.26—If the system identifier is present in the PRL, the device shall go to step 6.27 to check if this SID/NID is classified as negative. Otherwise it shall go to step 6.28 to check the PREF_ONLY flag.

Step 6.27—If the SID/NID is classified as negative, the device shall go to step 6.33 to scan the remaining channels and bands in the PRL Acquisition Table. Otherwise it shall go to step 6.29

Step 6.28—If the PREF_ONLY flag is set to true, the device shall go to step 6.33 to scan the remaining channels and bands in the PRL Acquisition Table. Otherwise the device shall go to step 6.29.

Step 6.29—If the detected system has the same priority in the PRL as the priority class of the currently examined item in MSPL (from step 3), the device shall go to step 6.30 (the priority classes for PRL and MSPL have been defined as in Table 1). If not, the device shall go to step 6.21.

Step 6.30—If the detected system is within the priority class HOME, the device shall go to step 8 to start registration procedures. Otherwise the device shall go to step 6.31.

Step 6.31—If the detected system is the most preferred one (due to its position in the PRL) within its MSPL priority class (PREF or ANY), the device shall go to step 8 to start registration procedures. Otherwise the device shall go to step 6.32.

Step 6.32—The device shall save in volatile memory the highest priority system found so far. If the system detected in step 6.24 has higher priority than the one previously saved (if any), it shall replace it. Otherwise the device shall retain the system already in memory.

Step 6.33—If all the channels and bands that appear in the PRL Acquisition Table have been scanned, the device shall go to step 6.34. Otherwise it shall go back to step 6.23 to scan the next channel/band in the PRL Acquisition Table not previously scanned.

Step 6.34—If a system has been saved in memory in steps 6.10 or 6.21 or 6.32, the device shall go to step 8 to start registration procedure for that system. Otherwise the device shall go to step 8 and subsequent check the next item in MSPL (step 4).

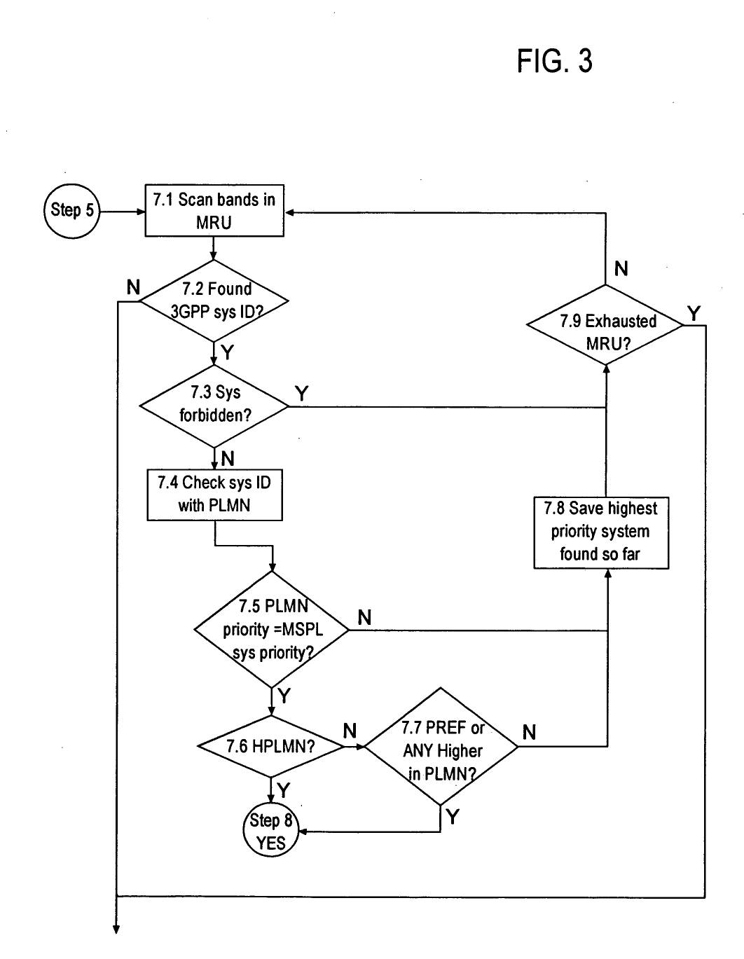

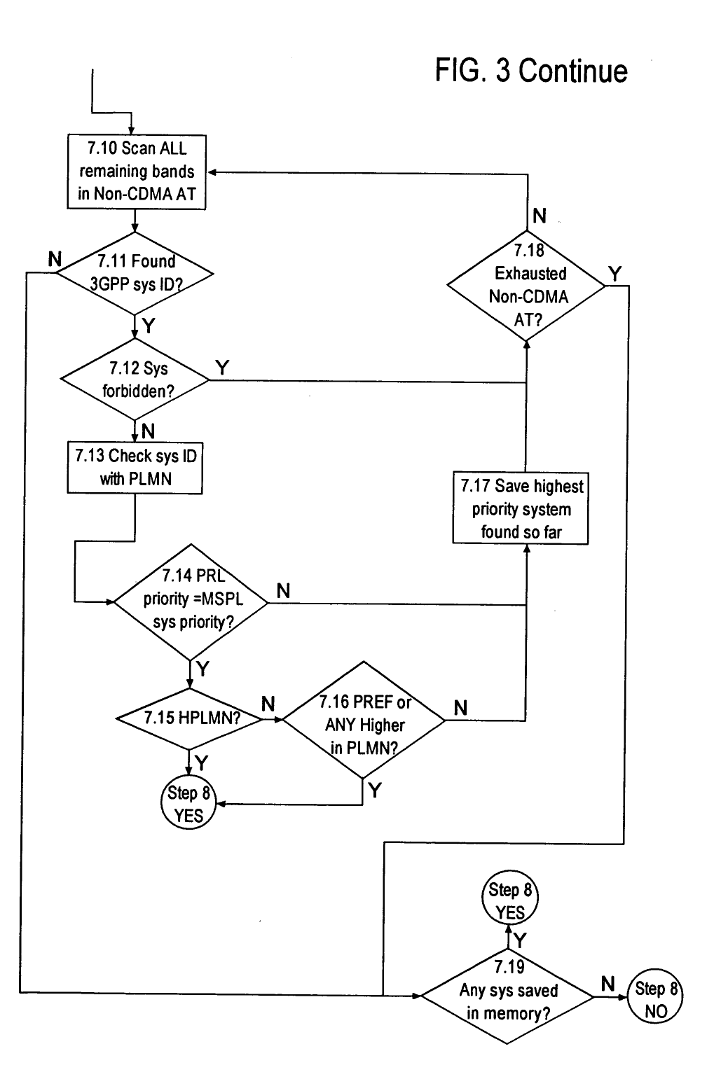

Step 7—The device shall use the 3GPP radio access technology (LTE, GSM, UMTS) that corresponds to the currently examined item in MSPL (step 3) to scan all the bands that appear in the MRU and PLMN lists to detect and select a system with the same priority class as the MSPL item in step 3. The device shall do so by going through the following steps (see FIG. 3):

Step 7.1—The device shall scan all the applicable bands that appear in the MRU list to detect a system identifier (PLMN). The device shall scan only the MRU bands that correspond to the desired radio access technology i.e. SYS_TYPE (LTE, GSM, UMTS) in the currently examined item in MSPL (step 3).

Step 7.2—If a system identifier is not detected in step 7.1, the device shall go to step 7.10. If a system identifier is detected, the device shall go to step 7.3.

Step 7.3—If the detected system is included in the FPLMN list (forbidden PLMNs), the device shall go to step 7.9 to scan the remaining bands in the MRU list. Otherwise the device shall go to step 7.4

Step 7.4—The device shall examine the eHPLMN, OPLMNwACT and PLMNwACT lists to find the detected system following the procedures in TS 23.122 “Non-Access-Stratum functions related to Mobile Station in idle mode” release 8.

Step 7.5—If the detected system has the same priority class as in the currently examined item in MSPL, the device shall go to step 7.6. If not, the device shall go to step 7.9 to scan the remaining bands in the MRU list. The priority classes for PLMNs and MSPL have been defined as in Table 1.

Step 7.6—If the detected system has priority class HOME (i.e. HPLMN or eHPLMN), the device shall go to step 8 to start registration procedures. Otherwise the device shall go to step 7.7.

Step 7.7—If the detected system is the highest priority system in the currently examined MSPL priority class (PREF or ANY respectively), the device shall go to step 8 to continue with registration procedures. Otherwise the device shall go to step 7.8.

Step 7.8—The device shall save in volatile memory the highest priority system found so far. If the system detected in step 7.2 has higher priority than the one previously saved (if any), it shall replace it. Otherwise the device shall retain the system already in memory.

Step 7.9—If all the bands that correspond to the desired radio access technology and appear in the MRU list have been scanned, the device shall go to step 7.10. Otherwise the device shall go back to step 7.1 to scan the next band in the MRU list.

Step 7.10—The device shall scan all the remaining bands in the Non-CDMA acquisition table (AT) that have not been previously scanned to detect a system identifier (PLMN). The device shall scan only the bands that correspond to the desired radio access technology i.e. SYS_TYPE (LTE, GSM, UMTS) in the currently examined item in MSPL (step 3).

Step 7.11—If a system identifier is not detected in step 7.11, the device shall go to step 7.19. If a system identifier is detected the device shall go to step 7.12.

Step 7.12—If the detected system is included in the FPLMN list (forbidden PLMNs), the device shall go to step 7.10 to examine the next item of the Non-CDMA AT corresponding to the desired radio access technology. Otherwise the device shall go to step 7.13

Step 7.13—The device shall examine the eHPLMN, OPLMNwACT and PLMNwACT lists to find the detected system following the procedures in TS 23.122 “Non-Access-Stratum functions related to Mobile Station in idle mode” release 8.

Step 7.14—If the detected system has the same priority class as in the current MSPL entry, the device shall go to step 7.15. If not, the device shall go to step 7.10 to scan the remaining bands in the Non-CDMA AT. The priority classes for PLMNs and MSPL have been defined the Table 1.

Step 7.15—If the detected system has priority HOME (i.e. HPLMN or eHPLMN), the device shall go to step 8 to start registration procedures. Otherwise the device shall go to step 7.16

Step 7.16—If the detected system is the highest priority system in the currently examined MSPL class (PREF or ANY respectively), the device shall go to step 8 to continue with registration procedures. Otherwise the device shall go to step 7.17.

Step 7.17—The device shall save in volatile memory the highest priority system found so far. If the system detected in step 6.24 has higher priority than the one previously saved (if any) it shall replace it. Otherwise the device shall retain the system already in memory.

Step 7.18—If all the bands for the desired radio access technology that appear in the non-CDMA AT list have been scanned, the device shall go to step 7.19. Otherwise it shall go back to step 7.10 to scan the next band in non-CDMA AT list.

Step 7.19—If a system has been saved in memory in steps 7.8 or 7.17, the device shall go to step 8 to start registration procedure for that system. Otherwise the device shall go to step 8 and subsequent check the next item in MSPL (step 4).

Step 8—If a 3GPP2 or 3GPP system has been found with the same priority class as in the currently examined item in MSPL, the device shall go to step 9 to register on that system. Otherwise the device shall go to step 11.

Step 9—The device shall attempt to register with the system it has chosen in step 6 (3GPP2 system) or in step 7 (3GPP)

Step 10—If registration has been successful the device shall go to step 15. Otherwise the device will go step 11. Registration could fail for a number of reasons defined in paragraph 4.3.3 in 3GPP TS 23.122 Non-Access Stratum (NAS) functions related to Mobile Station (MS) in idle mode Release 8, or because roaming agreements have changed without the PRL or MSPL having been updated yet.

Step 11—If the PRL or PLMN lists contain more than one system within the priority class as the currently examined item in the MSPL, the device shall go to step 5 to search for them. Otherwise the device shall go to step 12 to examine the next item in MSPL.

Step 12—The device shall check if all entries in the MSPL have been scanned. If not, the device shall go to step 4 to check the next entry in the MSPL list. Otherwise, the device shall go to step 13.

Step 13—The device shall check if T_scan>tsc. tsc is a generic timer. If T_scan>tsc the device shall go back to step 2 to start the whole process again. Otherwise the device will go to step 14.

Step 14—The device shall wait for a period of “power/save” duration and then go to step 1 to start the search again.

Step 15—The device shall check if the system it has registered on is the highest priority as defined in the MSPL for the country the device is operating. If it is, the device shall exit the Global Mode System Selection. Otherwise the device shall go to step 16 to start better system selection procedures.

Step 16—The device shall start the timer T_bsr_dig and then it shall go to step 17.

Step 17 If the device is in Idle mode and T_bsr_dig>higher_pri_srch_time, the device shall go back to step 3 in order to find a higher priority system. Otherwise the device shall go to step 18. The parameter higher_pri_srch_time is a timer defined in TIA/EIA/IS-683-D; Over-the-Air Service Provisioning of Mobile Stations in Spread Spectrum Systems, 2009, Telecommunications Industry Association.

Step 18—The device shall wait until it goes in idle mode and T_bsr_dig>higher_pri_srch_time. Then the device shall go to step 17 and then back to step 3.

To appreciate the application of the above-discussed algorithm, it may be helpful to consider the context of an exemplary system of networks as well as the hardware and software of an exemplary mobile station device, as may be involved in implementing the selection technique. The mobile station will be discussed later with regard to FIG. 5

FIG. 4 is a functional block diagram of an exemplary system of wireless networks for providing mobile voice telephone services and various data services. For discussion purposes, the diagram shows two wireless networks 10 and 30 operated in accord with different technology standards. The networks 10 and 30 often (but not always) may be operated by different providers, carriers or operators. The communication networks 10 and 30 implementing the illustrated system provide mobile voice telephone communications as well as other services such as text messaging and various multimedia packet data services, for numerous mobile stations. For purposes of later discussion three mobile stations 12, 13 and 33 appear in the drawing. The elements indicated by the reference numerals 10 and 30 generally are elements of the respective operator's network, although the mobile stations 12, 13 and 33 typically are sold to the carrier's customers. Today, mobile stations typically take the form portable handsets, smart-phones or personal digital assistants, data cards for computers, although they may be implemented in other form factors. Each mobile communication network 10 or 30 provides communications between mobile stations 12, 13 and 33 as well as communications for the mobile stations with other networks and stations shown generally at 11 outside the mobile communication networks. An inter-carrier or other intermediate network 29 may provide communication connectivity between the mobile communication networks 10 and 30.

Each network 10 and 30 allows users of the mobile stations operating through the respective network to initiate and receive telephone calls to each other as well as through the public switched telephone network (PSTN) 19 and telephone stations 21 connected thereto. One or both of the networks typically offers a variety of text and other data services, including services via the Internet 23, such as downloads, web browsing, e-mail, etc. via servers shown generally at 25 as well as message communications with terminal devices represented generally by the personal computer 27.

The networks 10 and 30 are generally similar, except in our example, they offer respective services via two different wireless communication technologies. For purposes of an example for discussion here, we will assume that the network 10 is a 3GPP2 (1×RTT and EVDO) technology network, whereas the network 30 is a 3GPP (LTE/GSM/UMTS) technology network.

The mobile communication network 10 typically is implemented by a number of interconnected networks. Hence, the overall network 10 may include a number of radio access networks (RANs), as well as regional ground networks interconnecting a number of RANs and a wide area network (WAN) interconnecting the regional ground networks to core network elements. A regional portion of the network 10, such as that serving mobile stations 13 will typically include one or more RANs and a regional circuit and/or packet switched network and associated signaling network facilities.

Physical elements of a RAN operated by one of the mobile service providers or carriers, include a number of base stations represented in the example by the base stations (BSs) 17. Although not separately shown, such a base station 17 typically comprises a base transceiver system (BTS) which communicates via an antennae system at the site of base station and over the airlink with one or more of the mobile stations 13, when the mobile stations are within range. The BTS is the part of the radio network that sends and receives RF signals to/from the mobile stations that the base station currently serves. Hence, in our example, the BTS would utilize 3GPP2 (1×RTT and EVDO) type transceiver equipment and implement communications in accord with the protocols of the applicable 3GPP2 standard, for signaling, registration, voice communication, data communication, etc. For example, each base station 17 will broadcast certain standardized information to allow a mobile station 12 or 13 in the region to search for, find and lock-onto the base station 17 and acquire information needed to register and initiate communications via the network 10, all in accord with the standard 3GPP2 protocols.

The radio access networks also include a traffic network represented generally by the cloud at 15, which carries the user communications for the mobile stations 12, 13 between the base stations 17 and other elements with or through which the mobile stations communicate. Individual elements such as switches and/or routers forming the traffic network 15 are omitted here for simplicity. Although not separately shown, the network 15 will include or connect with a number of service control elements, for authenticating mobile stations to use the network 10, for authenticating mobile device users and/or for authorizing users or devices to access various services and service features offered by the particular network 10, and for usage accounting and billing functions.

The traffic network portion 15 of the mobile communication network 10 connects to a public switched telephone network 19. This allows the network 10 to provide voice grade call connections between mobile stations and regular telephones connected to the PSTN 19. The drawing shows one such telephone at 21. The traffic network portion 15 of the mobile communication network 10 also connects to a public packet switched data communication network, such as the network commonly referred to as the “Internet” shown at 23. Packet switched communications via the traffic network 15 and the Internet 23 may support a variety of user services through the network 10, such as mobile station communications of text and multimedia messages, e-mail, web surfing or browsing, programming and media downloading, etc. For example, the mobile stations may be able to receive messages from and send messages to user terminal devices, such as personal computers, either directly (peer-to-peer) or via various servers 25. The drawing shows one user terminal device as a personal computer (PC) at 27, by way of example.

The carrier or service provider that operates the network 10 will also operate a number of systems that provide ancillary functions in support of the communications services provided through the network 10, and those elements communicate with other nodes/elements of the network 10 via one or more private IP type packet data networks or Intranets (not separately shown). Such systems maintain various records used for authentication and authorization functions and provisioning necessary information into the mobile stations to enable they operation via the network 10. Of note for purposes of the present discussion of the enhanced network or system selection function, one or more such systems provide the capability to download at least the lists and/or updates thereof into the mobile stations of the network operator, in this example, via the networks. These systems may also support downloading of the executable programming for the system selection via the networks, to initially install such programming in the mobile stations or to fix or update the programming in the mobile stations over time. An example of such a system that may facilitate programming and/or list downloading via the networks is the Over-The-Air service activation/provisioning Function (OTAF) 28. In the example, the OTAF 28 may be a server connected to the traffic network 15, to enable the server to communicate with the mobile stations of the network operator's customers.

As noted earlier, many mobile wireless communications networks have been deployed and are available today. For purposes of discussion the example of FIG. 4 shows a second mobile network 30. In our example, the network 30 is operated by a different carrier or service provider than the operator of network 10. In some areas, the second network 30 could utilize the same wireless technology as the network 10, but in our example, the network 30 utilizes a different wireless network technology. The network 10 is a 3GPP2 (1×RTT and EVDO) technology network, and in the example, the network 30 is a 3GPP (LTE/GSM/UMTS) technology network.

Like the network 10, the physical elements of the radio access network (RAN) 30 include a number of base stations (BSs) 37, each of which includes a base transceiver system (BTS) and associated antenna system. In our example, each BTS of a base station 37 would utilize 3GPP (LTE/GSM/UMTS) type transceiver equipment and implement communications in accord with the protocols of the applicable 3GPP standard, for signaling, registration, voice communication, data communication, etc. For example, each base station 37 will broadcast certain standardized information to allow a mobile station 12 or 33 in the region to search for, find and lock-onto the base station 37 and acquire information needed to register and initiate communications via the network 30, all in accord with the standard 3GPP protocols.

The radio access network portions of network 30 also include a traffic network represented generally by the cloud at 35, which carries the user communications for the mobile stations 12, 33 between the base stations 37 and other elements with or through which the mobile stations communicate. Individual elements such as switches and/or routers forming the traffic network 35 are omitted here for simplicity. Although not separately shown, the network 35 will include or connect with a number of service control elements, for authenticating mobile stations to use the network 30, for authenticating mobile device users and/or for authorizing users or devices to access various services and service features offered by the particular network 30.

Similar to network 10, the traffic network portion 35 of the mobile communication network 30 connects to a public switched telephone network 19, to offer voice grade telephone call connections between mobile stations and regular telephones 21 connected to the PSTN 19. The traffic network portion 35 of the mobile communication network 30 also connects to a public packet switched data communication network, such as the network commonly referred to as the “Internet” shown at 23, for various mobile station communications with servers 25 and/or user terminal devices 27. Although omitted for simplicity, the network 30 may also include various systems that provide ancillary functions in support of the communications services provided through the network 30, such as a system similar to the OTAF 29 for providing data and/or programming downloads to the mobile stations of the network operator's customers.

As discussed earlier, the selection technique of FIGS. 1 to 3 configures a mobile station to generally take advantage of the most favorable roaming agreements between network operators, when selecting networks or systems as the customer roams with the mobile station. Using the networks of FIG. 4 as an example, the algorithm provides the flexibility for a mobile station such as 12 to select between the 3GPP2 (1×RTT and EVDO) technologies of network 10 and the 3GPP (LTE/GSM/UMTS) technologies of network 30 as well as specific operators' networks for domestic and international roaming.

Assume that the mobile station 12 has dual mode capability to utilize both 3GPP2 and 3GPP technology networks. Via the OTAF server 29 or other means, the operator that provides service to the customer has installed the system selection programming to implement the algorithm of FIGS. 1 to 3 in the mobile station 12 and has downloaded the various lists discussed earlier relative to those flow charts. We will assume for discussion purposes that the station 12 is in an area where it can detect base station signaling from both networks 10 and 30 and therefore could use either one of those two networks upon selection and registration.

At a high level, the mobile station 12 identifies the country of current operation, typically from over-the-air signaling received from a base station 17 or 37 of a network in the current area of operation. The mobile station 12 uses its stored high order list, which identifies a preferred technology for each of the countries in which the operator's mobile stations may roam and obtain service, to initially select the preferred technology for the region within which the mobile station is currently operating. Although in many locations around the world the preference may be for 3GPP technology, for discussion purposes, assume that the mobile station 12 is operating in the US, and based on its high order list processing selects 3GPP2 as the preferred technology.

As discussed, the mobile station also utilizes a number of network or system preference lists supported by respective standards for the various network technologies that the mobile station is capable of using. In our current example, the mobile station device supports 3GPP2 technologies and 3GPP technologies, therefore the device has one or more PRL type lists for 3GPP2 network selection and one or more PLMN lists for 3GPP network selection. Having picked one of the technologies based on the country and the high order technology preference list, the 3GPP2 technology in the present example, the mobile station uses the selected one of the technologies to search for the most preferred network or system of the particular technology type using the corresponding system or network selection list. Essentially, the mobile station scans for system identifiers using the selected technology communications and picks the detected network or system of that technology that has the highest priority as indicated on the list corresponding to the selected technology. In the example of FIG. 4, since the 3GPP2 technology is preferred in the US, the mobile station 12 searches for a 3GPP2 network. Upon detection of the signaling from a base station 17 of the 3GPP2 type network 10, the mobile station determines the priority of the detected network from the PRL processing. If the detected network is sufficiently high (or no higher network is detected through the search and PRL processing), then, the mobile station 12 will select and register for communication via that identified network 10.

For purposes of further discussion, assume now that the mobile station 12 does not detect the network 10 and as a result can not find a network that is identified on the system or network preference list for the initially selected technology, 3GPP2 in our US example. In that case, the mobile station 12 selects another system preference list for an alternate technology and executes the procedure to identify and register with the most preferred network or system on the alternate list, in accord with the alternate standard, a 3GPP standard in this example. In the example of FIG. 4, the mobile station 12 therefore selects the PLMN list for further system selection processing, in accord with applicable 3GPP protocols and procedures. Upon detection of the signaling from a base station 37 of the 3GPP type network 30, the mobile station determines the priority of the detected network from the PLMN list processing. If the detected network 30 is sufficiently high (or no higher network is detected through the search and PLMN processing), then, the mobile station 12 will select and register for communication via that identified network 30.

As shown by the discussion above, the selection algorithm is implemented in each of the appropriately configured mobile stations. Although station 12 was discussed by way of example, the same selection technique may be implemented in any or all of the mobile stations 12, 13 and 33 which support multi-mode/technology operations, e.g. for global roaming capability. Those skilled in the art should be quite familiar with the structure, programming and operation of a variety of different mobile stations that might utilize the network selection algorithm discussed herein. However, for general completeness and to perhaps help some readers to appreciate an actual implementation of the selection technique, it may be helpful to briefly consider a high level example of a particular mobile station device.

FIG. 5 provides a block diagram illustration of an exemplary wireless device 100, which may be the wireless device 12, 13 or 33 of a customer of any of the network operators. Although the wireless device 100 may be a smart-phone or may be incorporated into another device, such as a portable personal computer, personal digital assistant (PDA) or the like, for discussion purposes, the illustration shows the wireless device 100 in the form of a handset. The handset embodiment of the wireless device 100 functions as a normal digital wireless telephone station. For that function, the station 100 includes a microphone 102 for audio signal input and a speaker 104 for audio signal output. The microphone 102 and speaker 104 connect to voice coding and decoding circuitry (vocoder) 106. For a voice telephone call, for example, the vocoder 106 provides two-way conversion between analog audio signals representing speech or other audio and digital samples at a compressed bit rate compatible with the digital protocol of wireless telephone network communications or voice over packet (Internet Protocol) communications.

For digital wireless communications, the handset 100 also includes at least one digital transceiver (XCVR) 108. The handset 100 is a multimode device capable of operations on various technology type networks, such as the networks 10 and 30. For example, the handset 100 may utilize either or both of 3GPP2 (1×RTT and EVDO) technologies and 3GPP (LTE/GSM/UMTS) technologies. For that purpose, the transceiver (XCVR) 108 could be a multimode transceiver, or the handset 100 may include two or more transceivers each of which supports a subset of the various technologies or modes. The concepts discussed here encompass embodiments of the station 100 utilizing any digital transceivers that conform to current or future developed digital wireless communication standards.

The transceiver 108 provides two-way wireless communication of information, such as vocoded speech samples and/or digital message information, in a selected one of the technology modes. The transceiver 108 also sends and receives a variety of signaling messages in support of the various voice and data services provided via the station 100 and the communication network (described earlier with regard to FIG. 4). Each transceiver 108 connects through RF send and receive amplifiers (not separately shown) to an antenna 110. In the example, the transceiver 108 is configured for RF communication in accord with a digital wireless protocol, such as the current 3GPP2 and 3GPP protocols. For the network selection function, network communications via the transceiver 108 and antenna 110 will include detection of the available network technology types in any given service area and selection of an available network for communications using the algorithm discussed above relative to FIGS. 1-3. The network communications may also support downloading of selection programming and list data and/or updates thereof from a server such as the OTAF server 29.

The station 100 includes a display 118 for displaying messages, menus or the like, call related information dialed by the user, calling party numbers, etc. A keypad 120 enables dialing digits for voice and/or data calls as well as generating selection inputs, for example, as may be keyed-in by the user based on a displayed menu or as a cursor control and selection of a highlighted item on a displayed screen. The display 118 and keypad 120 are the physical elements providing a textual or graphical user interface. In addition to normal telephone and data communication related input/output, these elements also may be used for display of menus and other information to the user and user input of selections, if needed during a system selection operation or during a selection software download operation. Various combinations of the keypad 120, display 118, microphone 102 and speaker 104 may be used as the physical input output elements of the GUI, for multimedia (e.g. audio and/or video) communications. Of course other user interface elements may be used, such as a stylus and touch sensitive display screen, as in a PDA or smart phone.

A microprocessor 112 serves as a programmable controller for the wireless device 100, in that it controls all operations of the wireless device 100 in accord with programming that it executes, for all normal operations, and for operations involved in selecting a preferred technology and selecting an available network of the appropriate technology type, for mobile communications. In the example, the wireless device 100 includes flash type program memory 114, for storage of various “software” or “firmware” program routines and mobile configuration settings, such as mobile directory number (MDN) and/or mobile identification number (MIN), etc. The wireless device 100 may also include a non-volatile random access memory (RAM) 116 for a working data processing memory. Of course, other storage devices or configurations may be added to or substituted for those in the example. In a present implementation, the flash type program memory 114 stores firmware such as a boot routine, device driver software, an operating system, call processing software and vocoder control software, and any of a wide variety of other applications, such as client browser software and short message service software. The memories 114, 116 also store various data, such as telephone numbers and server addresses, downloaded data such as multimedia content, and various data input by the user. Programming 122 stored in the flash type program memory 114, sometimes referred to as “firmware,” is loaded into and executed by the microprocessor 112.

The executable programming stored in the flash memory 114 will include a network selection program module 122. The data stored in the flash memory 114 will include the various lists used to select a technology or mode and select a network, in accord with the algorithm, such as the high order list(s) 124, the PLMN list 126 and the PRL 128.

3GPP variants of the mobile devices often utilize a Subscriber Identity Module or “SIM” card (called UICC in the 3GPP standards documents—universal integrated circuit card), which provides secure storage for various data needed for operation of a mobile station, such as data identifying the mobile station to the network (e.g. MDN and/or MIN). However, the SIM card is a standardized removable module can be moved from one mobile station device to another, to effectively move the mobile station identity from one device to another. As discussed above, the list data can be downloaded into flash memory or the like in the mobile station. In implementations using SIM cards, another approach would be to download at least the list data to SIM card storage. In existing 3GPP mobile devices, PLMN lists are stored on the SIM card. In which case, the higher order list(s) and/or PRL also could be on the SIM card or could be stored in other memory (e.g. flash memory) in the mobile station.

As shown by the above discussion, functions relating to the selection of a network for wireless communications to take advantage of the most favorable roaming agreements between operators may be implemented on in the form of programming and associated list data for controlling operations of a mobile station device. An example of the device has been discussed above relative to FIG. 5. As mentioned earlier, the relevant software (programming and/or list data) may be downloaded and/or updated from a computer platform, for example, from an OTAF server or the like communicating with the mobile station via the network. Although special purpose devices may be used to support the download and update functions, such devices also may be implemented using one or more hardware platforms intended to represent a general class of data processing device commonly used to run “server” and/or “client” programming so as to implement the functions discussed above, albeit with an appropriate network connection for data communication.

As known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data, e.g. files used for the various technology and system or network selection lists. The programming code is executable by the microprocessor 112 of the mobile station, e.g. from storage in the flash memory 114. For downloading and installation, however, the software is stored within the general-purpose computer platform or the like serving as the OTAF system.

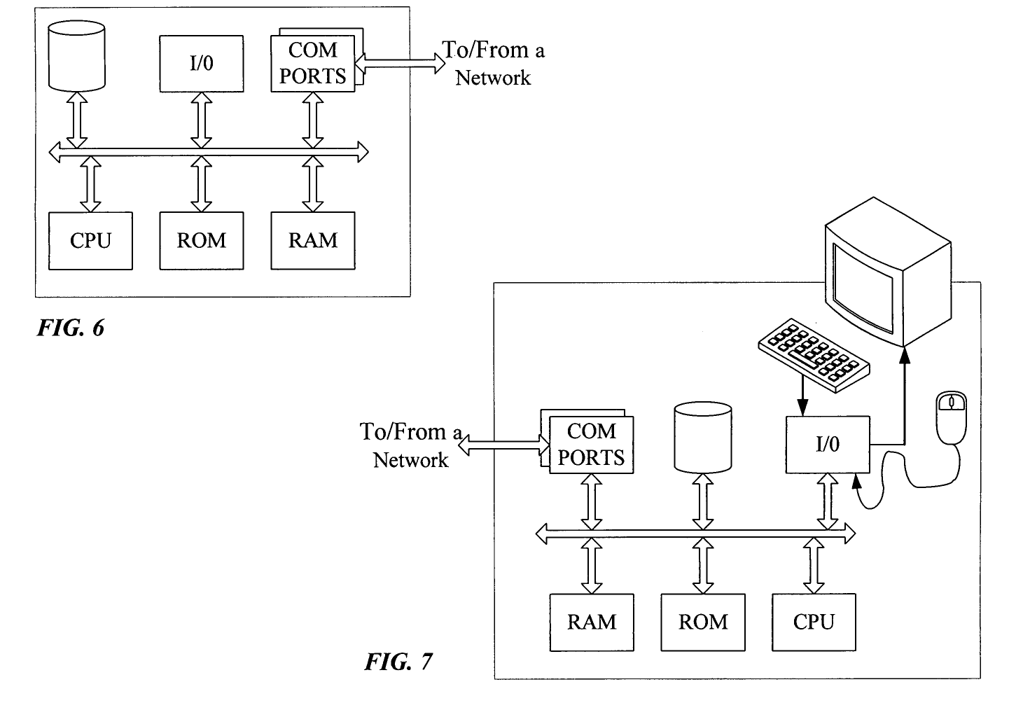

FIGS. 6 and 7 provide functional block diagram illustrations of general purpose computer hardware platforms. FIG. 6 illustrates a network or host computer platform, as may typically be used to implement a server. FIG. 7 depicts a computer with user interface elements, as may be used to implement a personal computer or other type of work station or terminal device, although the computer of FIG. 7 may also act as a server if appropriately programmed. It is believed that those skilled in the art are familiar with the structure, programming and general operation of such computer equipment and as a result the drawings should be self-explanatory.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature, and it is presumed that those skilled in the art are adequately familiar therewith. Of course, the server functions may be implemented in a distributed fashion on a number of similar platforms, to distribute the processing load.

Hence, aspects of the methods of network selection outlined above may be embodied in programming. Program aspects of the technology may be thought of as “products” or “articles of manufacture” typically in the form of executable code and/or associated list data that is carried on or embodied in a type of machine readable medium. “Storage” type media include any or all of the memory of the computers, processors or the like, or associated modules thereof, such as various semiconductor memories, tape drives, disk drives and the like, which may provide storage at any time for the software programming. All or portions of the software may at times be communicated through the Internet or various other telecommunication networks. Such communications, for example, may enable loading of the software from a computer or processor into the mobile station, for example, from the OTAF server or other computer of the network operator into the mobile station(s) of the operator's customer(s). Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or a physical transmission medium. Non-volatile storage media include, for example, optical or magnetic disks, such as any of the storage devices in any computer(s) or the like, such as may be used to implement the information flow control, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions and/or associated list data to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

### Appendix: Acronym List

The description above has used a large number of acronyms to refer to various services, messages and system components. Although generally known, use of several of these acronyms is not strictly standardized in the art. For the convenience of the reader, the following list correlates terms to acronyms, as used in the detailed description above.

1×RTT—One (1) times (×) Radio Transmission Technology

3GPP—Third (3rd) Generation Partnership Project

3GPP2—Third (3rd) Generation Partnership Project 2

AT—Acquisition Table

BS—Base Station

BTS—Base Transceiver System

CD—Compact Disk

CDR—Call Detail Record

CD-ROM—Compact Disk-Read Only Memory

CPU—Central Processing Unit

DVD—Digital Video Disk

DVD-ROM—Digital Video Disk-Read Only Memory

EEPROM—Electrically Erasable Programmable Read Only Memory

eHPLMN—equivalent Home PLMN list

EPROM—Erasable Programmable Read Only Memory

EVDO—1×/Evolution—Data Only

FPLMN—Forbidden PLMN list

GEO—GEOographic (area)

GSM—Global System for Mobile

HPLMN—Home PLMN list

ID—IDentification

IP—Internet Protocol

IR—InfraRed

LTE—Long Term Evolution

MCC—Mobile Country Code

MDN—Mobile Director Number

MIN—Mobile Identification Number

MLPL—Multi-mode Location-Associated Priority List

MNC—Mobile Network Code

MRU—Most Recently Used list

MS—Mobile Station

MSC—Mobile Switching Center

MSPL—Multi-mode System Priority List

MTSO—Mobile Telephone Switching Office

NAS—Non-Access Stratum

NID—Network Identifier

PDA—Personal Digital Assistant

OPLMNwACT—Operator preferred PLMN with Access Technologies list

OTAF—Over-The-Air service activation/provisioning Function

PCS—Personal Communication Service

PLMN—Public Land Mobile Network

PLMNwACT—user preferred Public Land Mobile Network with Access Technologies list

PRL—Preferred Roaming List

PROM—Programmable Read Only Memory

PSTN—Public Switched Telephone Network

RAM—Random Access Memory

RAN—Radio Access Network

RF—Radio Frequency

ROM—Read Only Memory

SID—System Identifier

SIM—Subscriber Identity Module

UICC—Universal Integrated Circuit Card

UMTS—Universal Mobile Telecommunications Systems

WAN—Wide Area Network

XCVR—Transceiver

What is claimed is:

1. A method of selecting a network for communications of a multi-mode mobile station, comprising steps of:
receiving a signal over the air from a mobile communication network;
from the received signal, determining a country in which the mobile communication network is located, as a country of current operation of the multi-mode mobile station;
from a list of countries specifying a preferred technology for each listed country, stored in the multi-mode mobile station, identifying the preferred technology for the country of current operation of the multi-mode mobile station;
from among a plurality of network preference lists corresponding to different technologies supported by the multi-mode mobile station, retrieving one network preference list from storage in the multi-mode mobile station, the retrieved network preference list corresponding to the preferred technology identified for the country of current operation of the multi-mode mobile station;
searching for a network in the country of current operation of the multi-mode mobile station, offering wireless mobile communication service via the identified preferred technology; and
selecting a wireless mobile communication network, offering wireless mobile communication service via the identified preferred technology, discovered during the searching, based on a preference indicated in the retrieved network preference list corresponding to the identified preferred technology.

2. The method of claim 1, further comprising registering the multi-mode mobile station communication service via the selected wireless mobile communication network.

3. The method of claim 1, wherein:
the multi-mode mobile station supports operation via at least one 3GPP2 technology and supports operation via at least one 3GPP technology;
for each country, the list of countries specifies a preference for one or more 3GPP2 technologies and one or more 3GPP technologies; and
the searching and selecting steps conform to a protocol of a selected one of the 3GPP2 and 3GPP technologies.

4. The method of claim 3, wherein:
one of the network preference lists is a Preferred Roaming List (PRL); and
one of the network preference lists is a Public Land Mobile Network (PLMN) list.

5. The method of claim 1, further comprising downloading one or more of the lists into storage in the multi-mode mobile station or in a SIM card for use with a mobile station.

6. A multi-mode mobile station configured to implement the steps of the method of claim 1 to select a network for communications of the mobile station.

7. An article of manufacture, comprising: instructions for causing a programmable multi-mode mobile station to implement the steps of the method of claim 1 to select a network for communications of the mobile station; and a machine readable storage medium bearing the instructions.

8. The article of manufacture of claim 7, further comprising the lists, wherein the machine readable storage medium also bears the lists.
